(19) United States
(12) Patent Application Publication
(10) Pub. No.: US 2024/0070265 A1
(43) Pub. Date: Feb. 29, 2024

(54) BACKUP PROTECTION SYSTEM AND METHOD

(71) Applicant: Salvador Technologies Ltd, Rehovot (IL)

(72) Inventors: Alexander YEVTUSHENKO, Qiryat Gat (IL); Oleg VUSIKER, Qiryat Gat (IL)

(21) Appl. No.: 18/215,334

(22) Filed: Jun. 28, 2023

(30) Foreign Application Priority Data
Aug. 23, 2022 (IL) 295876

(51) Int. Cl. G06F 21/54; G06F 11/14; G06F 21/55

(52) U.S. Cl. CPC G06F 21/54; G06F 11/1451; G06F 11/1461; G06F 21/554

(57) ABSTRACT

An independent backup system and method, for backing up data from a computer system. The system comprises: a non-volatile storage device; a microcontroller coupled to a hardware reset switch; an electric power consumption sensor adapted for measuring the electric power consumption of the storage device and communicating electric power consumption data to the microcontroller; and an on/off connection switch, controlled by the microcontroller and connecting the storage device to a computer system containing data to be backed up, wherein in a first learning stage, the connection switch is always on and the microcontroller receives from the electric power consumption sensor, electric power consumption data about the activity of the storage device in order to determine via activity patterns at which times the computer system is sending data to be backed up on the storage device, then in a second operation stage the microcontroller sends instructions to the connection switch to turn it off and the microcontroller only turns the connection switch on a predetermined time before the backup activity has been determined to start, and the microcontroller turns the connection switch off a predetermined time after the backup activity has been determined to end.

### CROSS-REFERENCE

This application claims the benefit of priority of Israeli Patent Application No. 295876, filed on Aug. 23, 2022, and incorporated herein by reference in its entirety.

### TECHNICAL FIELD

The present invention relates to computer data backup in general, and in particular to systems and methods for protecting access to backup storage locations.

### BACKGROUND ART

As computers and technology becomes essential to so many activities today, backing up computer data is a critical activity to safeguard important data. Backing up data is critical in case data is accidently or maliciously deleted, altered or has become inaccessible.

There are many scenarios in which a backup might be needed to retrieve data. A user may accidently delete data, modify data involuntarily or may lose external storage devices; hard drives may become corrupted and inaccessible either due to a hardware malfunction or a system error; finally, hostile sources such as a computer virus, hacking activities or malicious user activities may destroy data, delete data or may the data inaccessible.

### SUMMARY OF INVENTION

The present invention relates to an independent backup system, for backing up data from a computer system, comprising:
(i) a non-volatile storage device;
(ii) a microcontroller coupled to a hardware reset switch;
(iii) an electric power consumption sensor adapted for measuring the electric power consumption of the storage device and communicating electric power consumption data to the microcontroller;
(iv) an on/off connection switch, controlled by the microcontroller and connecting the storage device to a computer system containing data to be backed up,
wherein in a first learning stage, the connection switch is always on and the microcontroller receives from the electric power consumption sensor, electric power consumption data about the activity of the storage device in order to determine via activity patterns at which times the computer system is sending data to be backed up on the storage device, then in a second operation stage the microcontroller sends instructions to the connection switch to turn it off and the microcontroller only turns the connection switch on a predetermined time before the backup activity has been determined to start, and the microcontroller turns the connection switch off a predetermined time after the backup activity has been determined to end.

In some embodiments, in the learning stage the system uses statistical methods and/or machine learning algorithms to determine at which time the computer system is sending data to be backed up at the storage device.

In some embodiments, the microcontroller comprises or is coupled to non-volatile memory for storing information related to determined backup times and frequency.

In some embodiments, the non-volatile storage device comprises one or more hard disks.

In some embodiments, the non-volatile storage device is designated for backups only.

In some embodiments, pressing the hardware reset switch puts the system in a learning stage.

In some embodiments, the microcontroller turns on and off data connection and powerline connection at the connection switch.

In some embodiments, the microcontroller comprises a real-time clock (RTC) or a timer.

In some embodiments, the system further comprises a software module running on the computer system containing data to be backed up in order to detect abnormal activity on the data to be backed up, said abnormal activity signaling the possibility of a computer virus or malicious activities.

In some embodiments, the software module disconnects said storage device after determining the computer system contains a computer virus or after identifying malicious activities.

In some embodiments, the software module signals the microcontroller that it has identified a computer virus or malicious activities, via a one-way communication system between the computer system and the microcontroller.

In some embodiments, the one-way communication system is an electric diode enabling a one-way communication.

### BRIEF DESCRIPTION OF DRAWINGS

FIG. 1 is a block diagram of an embodiment of a backup system and a computer system comprising data to be backed up.

FIG. 2 shows an electric activity graph of the storage device in the learning phase.

FIG. 3 shows an electric activity graph of the storage device in the operation phase.

FIG. 4 is a block diagram of an embodiment of a backup system and a computer system comprising data to be backed up comprising an additional auxiliary microcontroller.

FIG. 5 is a block diagram of an embodiment of a backup system and a computer system comprising data to be backed up, and a data activity detector.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

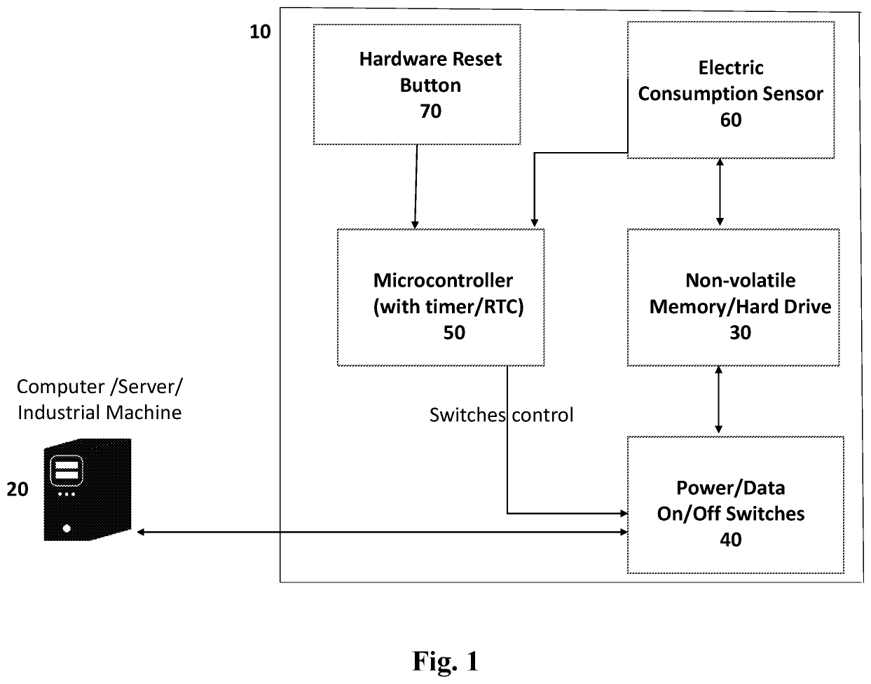

The present invention relates to systems and methods providing an independent backup system, for backing up data from a related computer system. Reference is now made to FIG. 1 showing an embodiment of an independent backup system 10 along a computer system 20 containing data to be backed up on the backup system 10.

The backup system 10 comprises a non-volatile storage device 30, such as a hard drive, an array of hard drives, a USB Flash memory, an SD memory card, any other non-volatile memory device, or any combination thereof. Non-volatile memory is characterized by maintaining the stored data even when the memory is not connected to a powerline or power source.

The storage device 30 is connected to an on/off connection switch 40 that controls power access and/or data access to the storage device 30. When the storage device 30 is disconnected from electric power (power switch off) or data access is not available (data switch is off) the storage device 30 is inaccessible thus maintaining the safety of the stored data, as it cannot be accessed or manipulated.

The storage device 30 is connected to the computer system 20 containing data to be backed up via the connection switch 40. The storage device 30 is accessible to the computer system 20 only when the connection switch 40 is on.

The power/connection switch 40 is controlled by a dedicated microcontroller 50 that is programmed to analyze, as will be discussed in greater detail below, the electric activity of the storage device 30 in order to deduct the times a backup is being performed and then turn off the connection switch 40 for most of the time so data is not accessible and its integrity is not at risk, and only turn on the connection switch 40 around the times that backup is to be performed.

An electric power consumption sensor 60 adapted for measuring electric power consumption is coupled to the storage device 30 and communicates the electric power consumption data of the storage device 30 to the microcontroller 50. Electric power (referred to as P) is the rate at which work is done or energy is transformed into an electrical circuit. Electric power is measured in watts and can be calculated by multiplying the electric current (referred to as I, and measured in amperes) by the voltage (aka electric potential, referred to as V and measured in volts), that is P=I*V. When the voltage is known, electric power consumption can be calculated by measuring the electric current, thus the electric power consumption sensor 60 may be an ampere meter (ammeter) device.

The microcontroller 50 is coupled to a hardware reset switch 70. Initially, the user presses the reset switch 70, putting the system in a first learning stage. In the first learning state, the connection switch 40 is always on and the microcontroller receives from the electric power consumption sensor 60, electric power consumption data about the activity of the storage device 30 in order to determine via activity patterns at which times the computer system 20 is sending data to be backed up on the storage device 30, then in a second operation stage the microcontroller 50 sends instructions to the connection switch 40 to turn it off and the microcontroller 50 only turns the connection switch 40 on a predetermined time before the backup activity has been determined to start, and the microcontroller 50 turns the connection switch 40 off a predetermined time after the backup activity has been determined to end.

It may happen that at one point the data to be backed up increases and more time will be needed for the backup process. In some cases, the allocated backup window has additional margins (a fixed additional amount of time, for example, additional 30 minutes, or an additional percentage of additional time, for example, additional 15% so if the back window is 60 minutes, the additional margin is 15% of 60 minutes, that is additional 9 minutes (total backup window will be 69 minutes).

Additionally, or alternatively, the system can continue to monitor the actual backup time, and adjust the backup window in accordance to current demand. That is, increase the backup window if more data needs to be backed up or decrease the backup window if less data needs to be backed up.

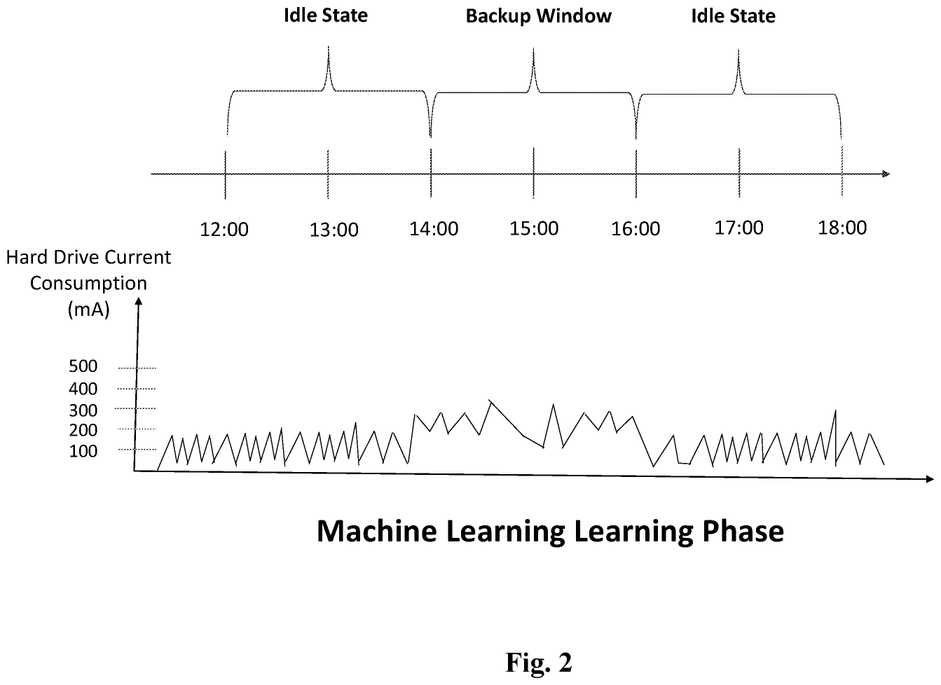

Reference is now made to FIG. 2 showing an electric activity graph of the storage device 30 in the first, learning phase. In the learning stage, the connection switch 40 is always on, and the storage device 30 is permanently connected and accessible from the computer system 20. As can be seen in the graph, a higher electric activity is recorded between 14:30 and 16:00. As the storage device 30 is only destined for backup activity, it is assumed that all activity detected is backup activity. The system studies the electric activity distribution using a variety of statistical methods and machine learning algorithms in order to determine with a predetermined level of confidence backup times and frequencies, for example, a statistical average of the current power consumption during a short time period (i.e., one minute), to determine in which minute the backup started and ended.

It is possible, that not all detected backups will be equal in time, as for example, a system might have a partial backup of only certain data say on Tuesday and a full backup on Sunday.

After the backup times and frequencies have been determined with the predetermined level of confidence, the first learning stage ends and the system moves to a second, operation stage. The system measures/determines the start of the backup window and the end of the backup window and the backup frequency (daily, weekly, every other day etc.), and in addition, the microcontroller 50 detects again the start and the finish of the backup window. If the calculation difference between the system time and the microcontroller 50 time is below a predetermined threshold (for example, less than 2 minutes deviation between consecutive days), the learning phase can be determined as finished.

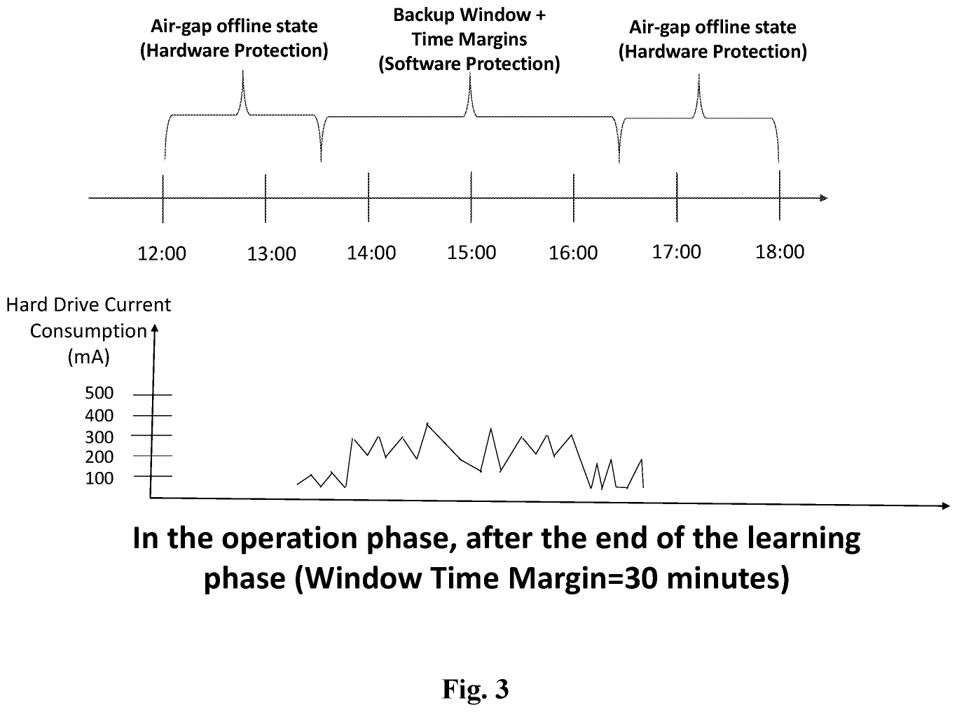

As illustrated in FIG. 3, in the operation stage the microcontroller 50 assures that the connection switch 40 is always off, except for the times a backup is scheduled. Preferably, and as shown in the graph of FIG. 3, the connection switch 40 stays on for a predetermined time before the start of the backup, and a predetermined time after the backup is supposed to end. The additional times before and after the backup don't have to be equal.

At any time during the operation phase, the user can choose to activate the hardware reset switch 70 and force the microcontroller 50 to enter the learning stage again. For example, in the case of moving the device to another computer, or changing the backup time or frequency by the user.

Daylight saving time and similar clock movement incidents require a special consideration. If the microcontroller 50 has a real-time clock (RTC), then daylight saving time clock changes will be automatically taken into consideration as the RTC will always reflect the right local time.

In cases where the microcontroller 50 is not aware on its own of clock movements, several solutions may be applied. The user may voluntarily press the hardware reset button 70 to have the system study the new backup times. This solution is not very practical, as it requires punctual user intervention every time the clock is moved backward or forward. Alternatively, the additional window before and after the backup may be set to a large value, say 90 minutes, so even if the clock moves one hour backward or ahead, the connection switch 40 will still be on, and backup could be performed. This solution can work but increases the time the storage device 30 is accessible, and thus increases the risk that something might happen to the stored data.

In some embodiments, the microcontroller 50 is fully autonomous (there is no communication between the microcontroller 50 and the computer system 20), this is done as to not allow to a malicious attacker to remotely manipulate the microcontroller 50.

Another solution is to have the backup application on the computer system 20 change the backup time to maintain the actual time the storage device 30 is accessible. For example, if the storage device 30 is accessible from 2 am to 4 am, and the clock moves one hour behind, the backup software should start the backup one hour later, that is at 3 am (equivalent to 2 am before daylight saving time was applied). This solution can work technically but requires adapting the backup software accordingly and also may be inconvenient to the user, if it has selected 2 am for backup time for a very specific reason. Alternatively, the backup schedule can be determined according to Universal Time Coordinated (UTC), which is not altered like the local time.

If daylight saving time is applied during the first, learning stage, the system will notice it as it will only finish the learning stage after backup times and frequency have been reliably determined for a predetermined time or predetermined number of occurrences.

In some embodiments, a special-purpose software application runs on the computer system 20 in order to detect viruses, cyber-attacks and suspicious anomalies, adding an additional layer of defense during the backup process. Threat detection may take place regularly, also including times the backup is not running. If a threat is detected, the software application may take defensive action such as disconnecting the storage device 30 from the computer system 20 side, for example, by performing an “eject” operation. Alternatively, or in addition, the software application may send a message to the microcontroller 50 via a hardware one-way communication architecture.

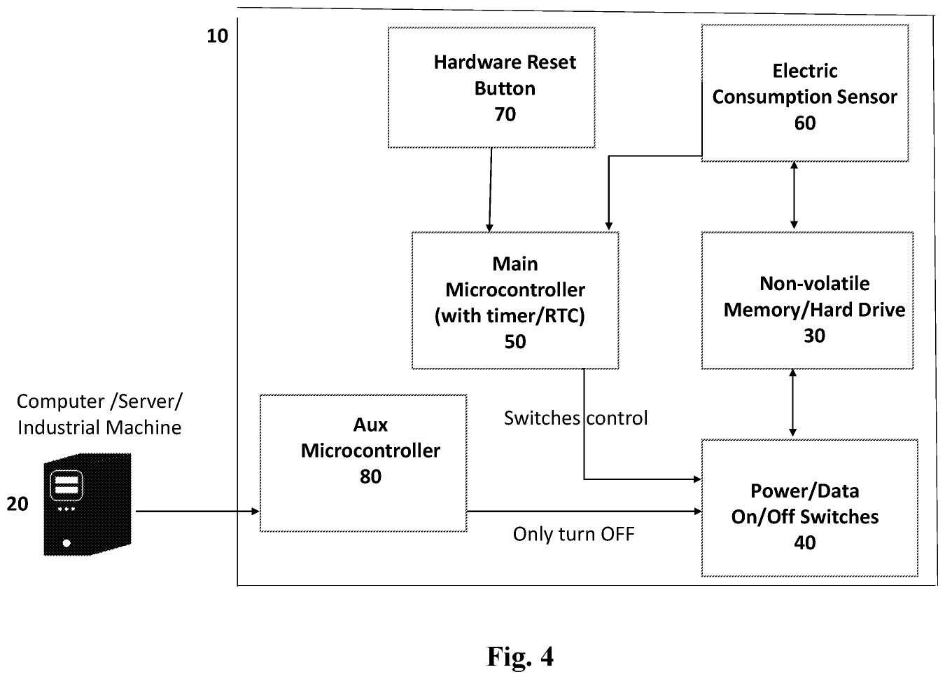

Reference is now made to FIG. 4, showing an embodiment where in order to make the architecture more secure, a dedicated auxiliary microcontroller 80 is added between the computer system 20 and the connection switch 40. The auxiliary microcontroller 80 can only turn off the disk 30. The auxiliary microcontroller 80 cannot turn on the disk 30 for added security. The auxiliary microcontroller 80 is not autonomous, and is controlled by the computer 20.

For example, cyber security software in the computer detects a cyber-attack (for example, by analyzing canary files), as a result, the software sends a command to the AUX microcontroller 80 which turns off the disk and prevents the attack to propagate to the backup (the attack might be detected before the window, during the window, or after the backup window).

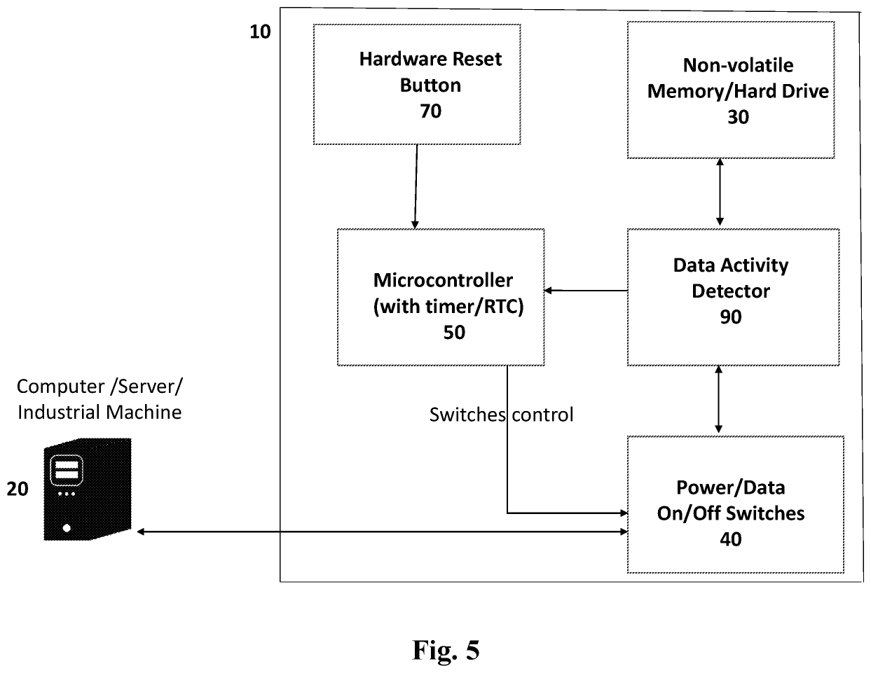

Reference is now made to FIG. 5, showing an embodiment where additional activity detection can be used instead of or in addition to the electric power consumption sensor 60. For example, a data activity detector 90 can be coupled to the hard drive 30 for analyzing the traffic between the computer 20 and the disk 30. A data activity detector 90 can be implemented by a data sniffer which analyzes the communication between the computer 20 and the storage 30. When the number of packets per minute is higher than a predetermined threshold, it means the backup activity has started (in the same manner the can detect when the backup activity has finished, as the number of packets per minute drop below a predetermined threshold value).

In another aspect, the present invention relates to an independent backup method, for backing up data from a computer system, comprising the steps:
(i) measuring the electric power consumption of a non-volatile storage device;
(ii) communicating said electric power consumption data to a microcontroller coupled to a hardware reset switch; and
(iii) connecting said storage device to a computer system containing data to be backed up via an on/off connection switch, controlled by said microcontroller,
wherein in a first learning stage, the connection switch is always on and the microcontroller receives from the electric power consumption sensor, electric power consumption data about the activity of the storage device in order to determine via activity patterns at which times the computer system is sending data to be backed up on the storage device, then in a second operation stage the microcontroller sends instructions to the connection switch to turn it off and the microcontroller only turns the connection switch on a predetermined time before the backup activity has been determined to start, and the microcontroller turns the connection switch off a predetermined time after the backup activity has been determined to end.

Although the invention has been described in detail, nevertheless, changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel.RTM. Pentium.RTM. or Centrino.TM. processor, that are adapted to communicate with the computer. Any number and type of machines may be in communication with the computer.

1. An independent backup system, for backing up data from a computer system, comprising:
(i) a non-volatile storage device;
(ii) a microcontroller coupled to a hardware reset switch;
(iii) an electric power consumption sensor adapted for measuring the electric power consumption of said storage device and communicating electric power consumption data to said microcontroller; and
(iv) an on/off connection switch, controlled by said microcontroller and connecting said storage device to a computer system containing data to be backed up,
wherein in a first learning stage, the connection switch is always on and the microcontroller receives from the electric power consumption sensor, electric power consumption data about the activity of the storage device in order to determine via activity patterns at which times the computer system is sending data to be backed up on the storage device, then in a second operation stage the microcontroller sends instructions to the connection switch to turn it off and the microcontroller only turns the connection switch on a predetermined time before the backup activity has been determined to start, and the microcontroller turns the connection switch off a predetermined time after the backup activity has been determined to end.

2. The independent backup system of claim 1, wherein in the learning stage the system uses statistical methods and/or machine learning algorithms to determine at which time the computer system is sending data to be backed up at the storage device.

3. The independent backup system of claim 1, wherein the microcontroller comprises or is coupled to non-volatile memory for storing information related to determined backup times and frequency.

4. The independent backup system of claim 1, wherein the non-volatile storage device comprises one or more hard disks.

5. The independent backup system of claim 1, wherein the non-volatile storage device is designated for backups only.

6. The independent backup system of claim 1, wherein pressing the hardware reset switch puts the system in a learning stage.

7. The independent backup system of claim 1, wherein the microcontroller turns on and off data connection and powerline connection at the connection switch.

8. The independent backup system of claim 1, wherein the microcontroller comprises a real-time clock (RTC) or a timer.

9. The independent backup system of claim 1, further comprising a software module running on the computer system containing data to be backed up in order to detect abnormal activity on the data to be backed up, said abnormal activity signaling the possibility of a computer virus or malicious activities.

10. The independent backup system of claim 9, wherein said software module disconnects said storage device after determining said computer system contains a computer virus or after identifying malicious activities.

11. The independent backup system of claim 9, wherein said software module signals the microcontroller that it has identified a computer virus or malicious activities, via a one-way communication system between the computer system and the microcontroller.

12. The independent backup system of claim 11, wherein said one-way communication system is an electric diode enabling a one-way communication.

13. The independent backup system of claim 1, further comprising a data activity detector.

14. An independent backup method, for backing up data from a computer system, comprising the steps:
(i) measuring the electric power consumption of a non-volatile storage device;
(ii) communicating said electric power consumption data to a microcontroller coupled to a hardware reset switch; and
(iii) connecting said storage device to a computer system containing data to be backed up via an on/off connection switch, controlled by said microcontroller,
wherein in a first learning stage, the connection switch is always on and the microcontroller receives from the electric power consumption sensor, electric power consumption data about the activity of the storage device in order to determine via activity patterns at which times the computer system is sending data to be backed up on the storage device, then in a second operation stage the microcontroller sends instructions to the connection switch to turn it off and the microcontroller only turns the connection switch on a predetermined time before the backup activity has been determined to start, and the microcontroller turns the connection switch off a predetermined time after the backup activity has been determined to end.

15. The independent backup method of claim 14, wherein in the learning stage the system uses statistical methods and/or machine learning algorithms to determine at which time the computer system is sending data to be backed up at the storage device.

16. The independent backup method of claim 14, wherein the microcontroller comprises or is coupled to non-volatile memory for storing information related to determined backup times and frequency.

17. The independent backup method of claim 14, wherein the non-volatile storage device comprises one or more hard disks.

18. The independent backup method of claim 14, wherein the non-volatile storage device is designated for backups only.

19. The independent backup method of claim 14, wherein pressing the hardware reset switch puts the system in a learning stage.

20. The independent backup method of claim 14, wherein the microcontroller turns on and off data connection and powerline connection at the connection switch.
